(19) United States
(12) Patent Application Publication
(10) Pub. No.: US 2007/0168435 A1
(43) Pub. Date: Jul. 19, 2007

(54) Method for archiving native email

(76) Inventors: William L. Moraca JR., McLean, VA (US); Gregory J. Boss, American Fork, UT (US); Timothy M. Waters, Hiram, GA (US); Rick A. Hamilton II, Charlottesville, VA (US)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/335,450

(22) Filed: Jan. 19, 2006

(51) Int. Cl. G06F 15/16

(52) U.S. Cl. 709/206

(57) ABSTRACT

A method of archiving email that includes receiving an email on an email server, determining whether to archive the email based upon received archive control commands and then archiving the a copy of the email in native format in a pre-designated file system on the email server. The method further comprises deleting the email from the mailbox and using a store function to trigger backup program, which moves the file from the pre-designated file system onto the backup server.

### FIELD OF INVENTION

The present invention generally relates to archiving email. More specifically, the invention relates to the archiving of individual email in a native format without the use of a third-party product.

### BACKGROUND OF THE INVENTION

Mail archival and retrieval capabilities exist within email applications today. Additionally, third-party software application and programming interfaces allow non archiving email applications to archive and retrieve individual emails, in addition to entire email “mailboxes.” With more and more emails being used as legal evidence often years after it was produced, new compliance regulations for proper electronic document accessibility have appeared—most recently in the Open Records Act, requiring that email be stored for longer periods of time. These compliance issues have to be balanced against the ever-increasing cost of storing emails for the long term on expensive storage devices in a centralized fashion.

In order to manage the size of email databases, email administrators have used, for example, quota policies to limit the number of stored emails and to alleviate the costs associated with the storage of the email content. However, one drawback of the available email storage methods is that they require third-party connect agents and software to bridge the gap between the email application and the centrally managed backup and archive solution. Another drawback is that though the available third-party software (e.g., KVS) and native features (e.g., export/import) allow for the archival and retrieval of an individual email message, they do not preserve the formatting of the original email or save the attachments contained within the original email.

FIG. 1 illustrates one example of a current system for archiving email using third-party products. The system consist of an email client application 115 such as Lotus Notes or Microsoft Exchange, an email server 120, and a backup server 130. An email server application 121 such as Lotus Notes or Microsoft Exchange is located on email server 120. Storage Area Network (SAN) based client programs 128 and non SAN based backup client programs 127 are also located within email server 120. Presently, in order to archive email from email server 120 to backup server 130, Application Program Interfaces (APIs) for both the email server application and the backup client must interact. Third-party products 126 are necessary to perform the interaction. It is desirable to provide a system and method for storing email that overcomes these and other disadvantages.

### SUMMARY OF THE INVENTION

One aspect of the invention provides for a method of archiving email. The method of archiving email includes receiving an email on an email server, determining whether to archive the email based upon received archive control commands and then archiving the a copy of the email in native format in a pre-designated file system on the email server. The method further comprises deleting the email from the mailbox and using a store function to trigger backup program, which moves the file from the pre-designated file system onto the backup server.

Another aspect of the invention provides a computer readable medium including computer readable code for archiving email. The computer readable medium includes computer readable code for receiving an email at a user mailbox on an email server, computer readable code for determining whether to archive at least one email based on an archive control command, computer readable code for archiving at least one email in native format in a pre-designated file system on the email server based on the determination and computer readable code for storing the at least one email on a backup server in response to archiving the at least one email.

Yet another aspect of the invention provides a system for archiving email. The system includes means for receiving an email at a user mailbox on an email server, means for determining whether to archive at least one email based on an archive control command, means for archiving at least one email in native format in a pre-designated file system on the email server based on the determination and means for storing the at least one email on a backup server in response to archiving the at least one email.

The forgoing embodiment and other embodiments, objects and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 is a block diagram illustrating a prior art email archiving system;

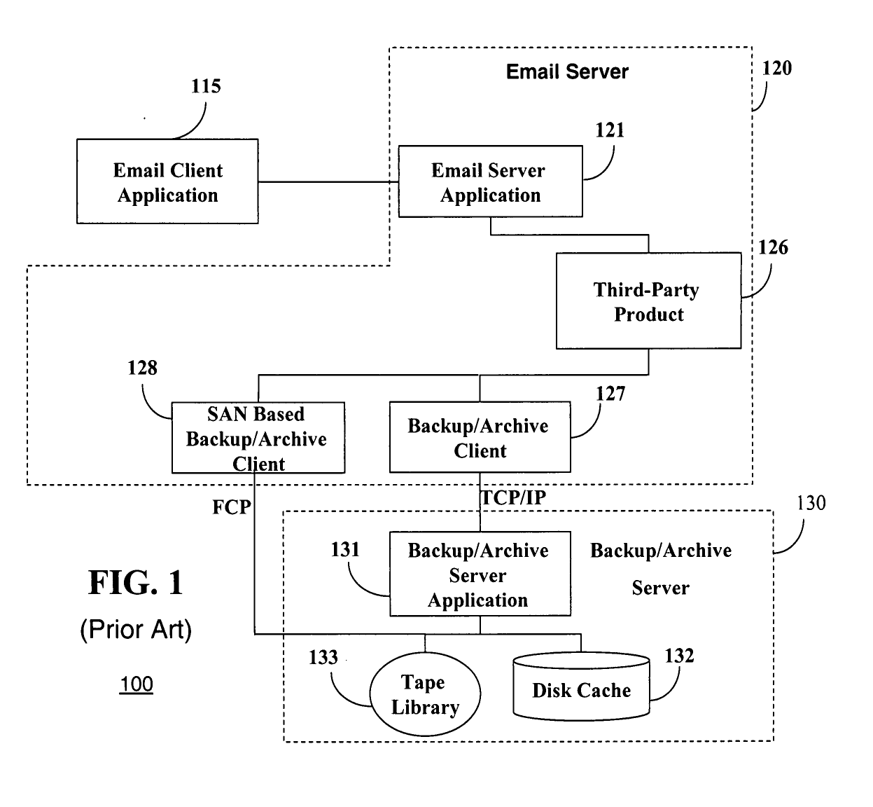

FIG. 2A illustrates one embodiment of a network system for use in accordance with one aspect of the invention;

FIG. 2B illustrates one embodiment of a computer for use in accordance with one aspect of the invention;

FIG. 3 is a block diagram illustrating one embodiment of a native email archival system made in accordance with the present invention;

FIG. 4 is a flow chart illustrating one embodiment of a method of archiving email in accordance with the present invention;

FIG. 5 is a block diagram illustrating one embodiment of a method of retrieving email in accordance with the present invention.

### DETAILED DESCRIPTION OF THE INVENTION

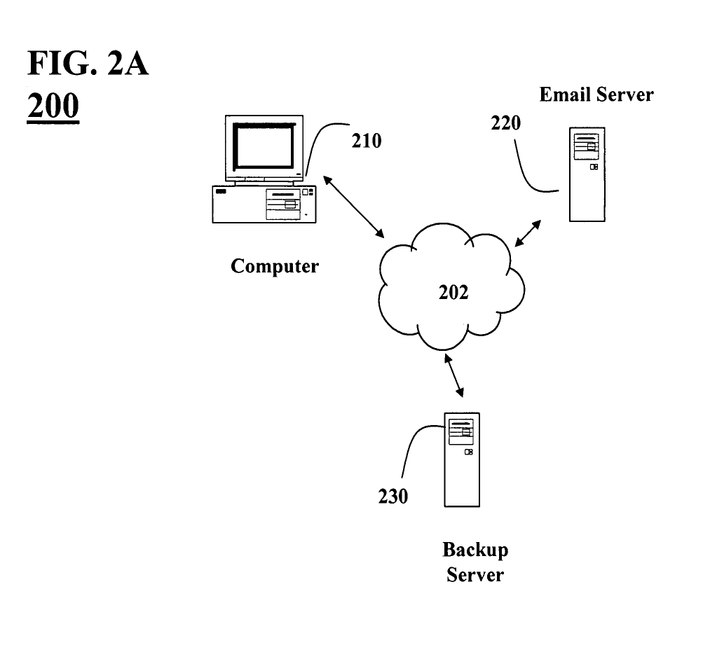

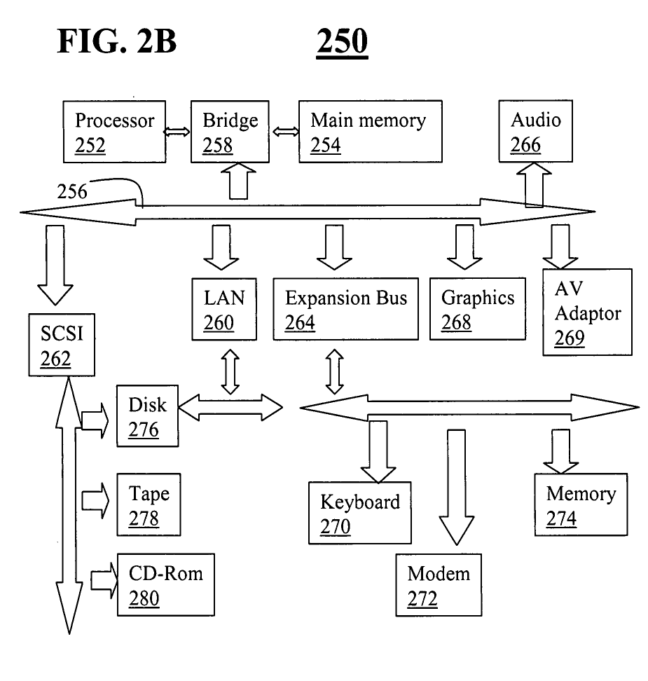

FIG. 2A illustrates one embodiment of a network system 200 for archiving email. Network system 200 is illustrative only and is not an architectural limitation for the practice of this invention. Network system 200 includes network 202, which is the medium used to provide communication links between various devices and computers connected together within distributed network system 200. Network 202 may include permanent connections, such as wire or fiber optic cables, or temporary connections made through telephone connections. In other embodiments, network 202 includes wireless connections using any appropriate wireless communications protocol including short range wireless protocols and/or long range wireless protocols such as a satellite or cellular protocol.

In FIG. 2A, connections to network 202 include a computer 210, an email server 220 and a backup server 230. Network system 200 may include additional servers and other devices not shown. FIG. 2A merely illustrates a basic system for archiving email. For purposes of this application, a network computer is any computer, coupled to a network. In the depicted example, server 220 provides data, such as boot files, operating system images, and applications to computer 210. Computer 210 is a client to servers 220 and 230. Network system 200 may include additional servers, clients, and other devices not shown. In the depicted example, network system 200 is the Internet with network 202 representing a worldwide collection of networks and gateways that use the TCP/IP suite of protocols to communicate with one another. Network system 200 also may be implemented as a number of different types of networks, such as for example, an intranet or a local area network.

FIG. 2B illustrates one embodiment of a computer client 250 for use in accordance with one aspect of the invention. Computer system 250 is an example of a client computer, such as client 210. Computer system 250 employs a peripheral component interconnect (PCI) local bus architecture. Although the depicted example employs a PCI bus, other bus architectures such as Micro Channel and ISA may be used. PCI bridge 258 connects processor 252 and main memory 254 to PCI local bus 256. PCI bridge 258 also may include an integrated memory controller and cache memory for processor 252. Additional connections to PCI local bus 256 may be made through direct component interconnection or through add-in boards. In the depicted example, local area network (LAN) adapter 260, SCSI host bus adapter 262, and expansion bus interface 264 are connected to PCI local bus 256 by direct component connection. In contrast, audio adapter 266, graphics adapter 268, and audio/video adapter (A/V) 269 are connected to PCI local bus 256 by add-in boards inserted into expansion slots. Expansion bus interface 264 connects a keyboard and mouse adapter 270, modem 272, and additional memory 274 to bus 256. SCSI host bus adapter 262 provides a connection for hard disk drive 276, tape drive 278, and CD-ROM 280 in the depicted example. In one embodiment, the PCI local bus implementation support three or four PCI expansion slots or add-in connectors, although any number of PCI expansion slots or add-in connectors can be used to practice the invention.

An operating system runs on processor 252 to coordinate and provide control of various components within computer system 250. The operating system may be any appropriate available operating system such as Windows, Macintosh, UNIX, LINUX, or OS/2, which is available from International Business Machines Corporation. “OS/2” is a trademark of International Business Machines Corporation. Instructions for the operating system, an object-oriented operating system, and applications or programs are located on storage devices, such as hard disk drive 276 and may be loaded into main memory 254 for execution by processor 252.

Those of ordinary skill in the art will appreciate that the hardware in FIG. 2B may vary depending on the implementation. For example, other peripheral devices, such as optical disk drives and the like may be used in addition to or in place of the hardware depicted in FIG. 2B. FIG. 2B does not illustrate any architectural limitations with respect to the present invention, and rather merely discloses an exemplary system that could be used to practice the invention. For example, the processes of the present invention may be applied to multiprocessor data processing system.

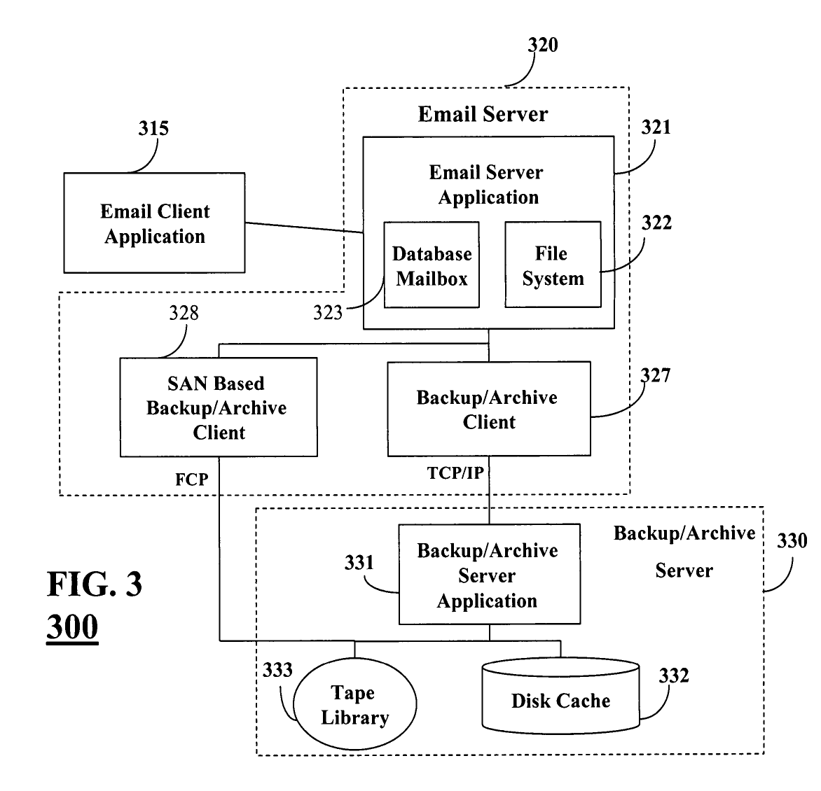

FIG. 3 illustrates one embodiment of a system 300 for archiving received email. System 300 includes an email client application 315, an email server 320 and a backup/archive server 330. In one embodiment, email client application 315 is located on user computer 210. Email client application 315 may be, for example, Lotus Notes or Microsoft Exchange. Network 202 connects email client application 315 to email server 320. Email server application 321 located on email server 320 permits communication between email client application 315 and email server 320. Email server application 321 may be, for example, applications such as Lotus Notes and Microsoft Exchange. Email server application 321 includes native email archive software, a database mailbox 323 and a pre-designated file system 322.

In one embodiment, email server 320 also includes a Storage Area Network (SAN) based backup client 328 and a non-SAN based backup client 327. Backup server 330 is operably connected to email server 320. In one embodiment, backup server 330 comprises server application 331, a tape library 333 and a disk cache 332. A SAN based backup client 328 sends files directly to a tape library 333 and a disk cache 332 via FCP. The non-SAN based backup client 327 sends the files via an FTP/IP through a backup server application 331 located on the backup server 330. The backup server application 331 then sends the files to the tape library 333 and disk cache 332. In one embodiment, the most recently accessed files are stored in the disk cache 332 and the long-term files are stored in the tape library 333.

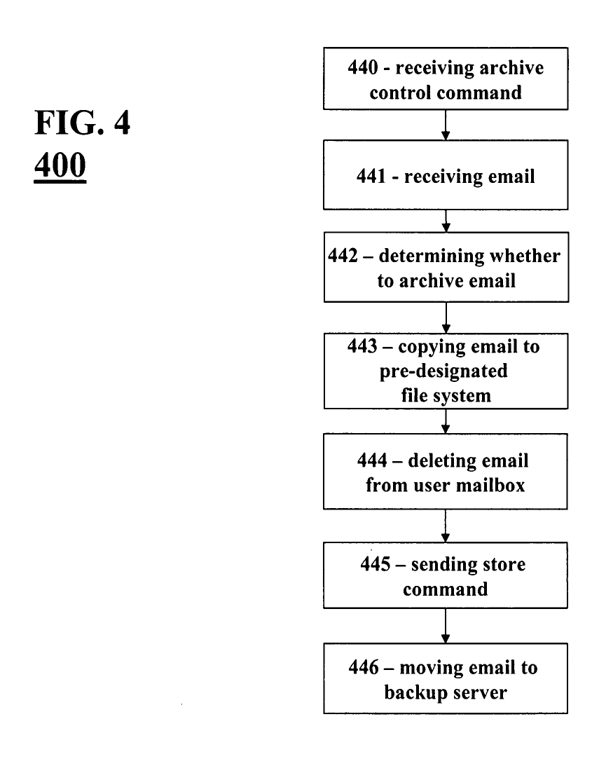

FIG. 4 illustrates one embodiment of a method 400 for archiving email, made in accordance with the present invention. Method 400 begins at step 440 when email server 320 receives at least one archival control command. In one embodiment, the archive control command includes at least one archive control parameter such as, for example, a number, a character, and a set of characters. The archival control command becomes integrated within the native email archival system and method located on email server 320.

In one embodiment, email server 320 receives at least one email at step 441 and then determines whether or not to archive at least one received email, step 442. In one embodiment, the determination comprises comparing the received email to the received archive control command. In one embodiment, this comparison permits archiving email based on parameters such as date, sender, subject and a word or phrase contained in the body. In another embodiment, email server 320 receives at least one email and then compares the archive control command with the user mailbox at step 442. In this embodiment, the contents of the mailbox are relevant and the content of specific email is irrelevant. In one embodiment, the comparison of the mailbox allows archival of email based upon parameters such as mailbox size. As illustrated in FIG. 4, when email server 320 receives email that triggers the archival process at step 442, a copy of the email is created in native format and placed in pre-designated file system 322 (Step 443). Pre-designated file system 322 is located within email server application 321 on email server 320. In step 444, the email is deleted from user mailbox 323 located on email server 320. Deletion of the email from the user mailbox triggers the store function in step 445.The store function instructs the backup program, SAN based 328 or non-SAN based 327, to move the email from the pre-designated file system to the backup server (Step 446). The email is now stored in native format on the backup server.

In another embodiment of the method, email stored on the backup server 330 is dynamically linked to the mailbox on the email server 323. This provides for a macro level control for archiving email in a manner unnoticeable to the user.

In yet another embodiment of the invention, the email filename is arbitrary. In one embodiment the email file name is comprised of the message ID, which is unique to every individual email sent. Thus, the email server application and the backup server share management of the email filename.

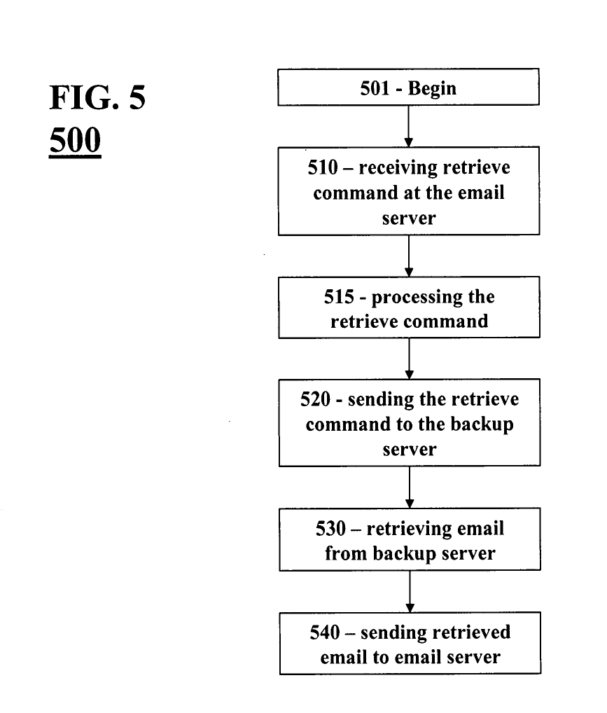

FIG. 5 illustrates one embodiment of a method 500 for retrieving an email stored on the backup server. Method 500 begins at 501.

At step 510, the email server 320 receives a command to retrieve an email, having a specific file name, from the backup server. Email server application 321 processes the command received at the email server at step 515. At step 520, email server application 321 sends the retrieve command to backup programs 327 and 328. Receipt of the retrieve command by backup programs 327 and 328 triggers at least one of the backup programs 327 or 328 to retrieve the email from backup server 330, at step 530. The retrieved email is then sent to mailbox 323 located on email server 320, at step 540.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

1. A method of archiving email, the method comprising:
receiving an email at a user mailbox on an email server;
determining whether to archive at least one email based on an archive control command;
archiving at least one email in a native format in a pre-designated file system on the email server based on the determination; and
storing the at least one email in the native format on a backup server in response to archiving the at least one email.

2. The method of claim 1 wherein determining whether to archive the at least one email based on an archive control command further comprises:
receiving at least one archive control command at the email server; and
comparing the archive control command with the at least one email on the email server.

3. The method of claim 1 wherein determining whether to archive the at least one email based on an archive control command further comprises:
receiving at least one archive control command at the email server; and
comparing the archive control command with the user mailbox on the email server.

4. The method of claim 1 wherein the archive control command is selected from a group consisting of mailbox size, an email tag, a date, a sender name, a keyword, a key phrase, a character, a set of characters, a number, and a set of numbers.

5. The method of claim 1 wherein archiving the at least one email in a pre-designated file system on the email server comprises:
copying the at least one email in the native format onto a pre-designated file system on the email server; and
deleting the at least one email from the user mailbox in response to the copying.

6. The method of claim 1 wherein storing the at least one email on a backup server in response to archiving the at least one email comprises:
sending a store command to a backup program located on the email server; and
moving the at least one email from a pre-designated file system on the email server to the backup server by the backup program.

7. The method of claim 6 wherein retrieving the at least one stored email comprises:
receiving at least one retrieve command and at least one email filename at the email server.
sending the retrieve command and email filename to backup program; and
moving the email that matches filename from backup sever by backup program to the mailbox on the email server.

8. A computer readable medium including computer readable code for archiving email, the medium comprising:
computer readable code for receiving an email at a user mailbox on an email server;
computer readable code for determining whether to archive at least one email based on an archive control command;
computer readable code for archiving at least one email in native format in a pre-designated file system on the email server based on the determination; and
computer readable code for storing the at least one email on a backup server in response to archiving the at least one email.

9. The method of claim 8 wherein the computer readable code for determining whether to archive the at least one email based on an archive control command further comprises:
computer readable code for receiving at least one archive control command at the email server; and
computer readable code for comparing the archive control command with the at least one email on the email server.

10. The method of claim 8 wherein the computer readable code for determining whether to archive the at least one email based on an archive control command further comprises:
computer readable code for receiving at least one archive control command at the email server; and
computer readable code for comparing the archive control command with the user mailbox on the email server.

11. The method of claim 8 wherein the computer readable code for archiving the at least one email in a pre-designated file system on the email server comprises:
computer readable code for copying the at least one email in the native format onto a pre- designated file system on the email server; and
computer readable code for deleting the at least one email from the user mailbox in response to the copying.

12. The method of claim 8 wherein the computer readable code for storing the at least one email on a backup server in response to archiving the at least one email comprises:
computer readable code for sending a store command to a backup program located on the email server; and
computer readable code for moving the at least one email from a pre-designated file system on the email server to the backup server by the backup program.

13. The method of claim 12 wherein the retrieving the at least one stored email comprises:
computer readable code for receiving at least one retrieve command and at least one email filename at the email server.
computer readable code for sending the retrieve command and email filename to the backup program; and
computer readable code for moving the email that matches filename from backup sever by backup program to the mailbox on the email server.

14. A system of archiving email, the system comprising:
means for receiving an email at a user mailbox on an email server;
means for determining whether to archive at least one email based on an archive control command;
means for archiving at least one email in native format in a pre-designated file system on the email server based on the determination; and
means for storing the at least one email on a backup server in response to archiving the at least one email.

15. The system of claim 14 wherein the means for determining whether to archive the at least one email based on an archive control command further comprises:
means for receiving at least one archive control command at the email server; and
means for comparing the archive control command with the at least one email on the email server.

16. The system of claim 14 wherein the means for determining whether to archive the at least one email based on an archive control command further comprises:
means for receiving at least one archive control command at the email server; and
means for comparing the archive control command with the user mailbox on the email server.

17. The system of claim 14 wherein the means for archiving the at least one email in a pre-designated file system on the email server comprises:
means for copying the at least one email in the native format onto a pre-designated file system on the email server; and
means for deleting the at least one email from the user mailbox in response to the copying.

18. The system of claim 14 wherein the means for storing the at least one email on a backup server in response to archiving the at least one email comprises:
means for sending a store command to a backup program located on the email server; and
means for moving the at least one email from a pre-designated file system on the email server to the backup server by the backup program.

19. The system of claim 18 wherein the means for retrieving the at least one stored email comprises:
means for receiving at least one retrieve command and at least one email filename at the email server.
means for sending the retrieve command and email filename to backup program; and
means for moving the email that matches filename from backup sever by backup program to the mailbox on the email server.
